(19) United States
(12) Patent Application Publication
(10) Pub. No.: US 2007/0258869 A1
(43) Pub. Date: Nov. 8, 2007

(54) Residue Conditioning System

(76) Inventors: Andreas Tsangaris, Ottawa (CA); Margaret Swain, Ottawa (CA)

Correspondence Address: MBM & CO., 270 ALBERT STREET, 14TH FLOOR, OTTAWA, ONTARIO, K1P 5G8, CA

(21) Appl. No.: 11/745,406

(22) Filed: May 7, 2007

Related U.S. Application Data
(60) Provisional application No. 60/746,628, filed on May 5, 2006.
(60) Provisional application No. 60/864,116, filed on Nov. 2, 2006.
(60) Provisional application No. 60/911,179, filed on Apr. 11, 2007.
(60) Provisional application No. 60/797,973, filed on May 5, 2006.

(51) Int. Cl. B09B 3/00; F23G 5/00

(52) U.S. Cl. 422/184.1; 422/186.04; 48/209; 110/250

(57) ABSTRACT

The present invention provides a system for converting the residue of a carbonaceous feedstock gasification or incineration process into an inert slag and a gas having a heating value. The residue is converted by plasma heating in a refractory-lined residue conditioning chamber. The gas produced is optionally passed through a gas conditioning system for cooling and cleaning to provide a product gas that is suitable for use in downstream applications. The system also comprises a control subsystem for optimizing the conversion reaction

### CROSS REFERENCE TO RELATED APPLICATIONS

This application claims benefit of priority under 35 U.S.C. §119(e) from U.S. Provisional Application Ser. No. 60/746,628, filed May 5, 2006. This application also claims benefit of priority under 35 U.S.C. §119(e) from U.S. Provisional Application Ser. No. 60/864,116, filed Nov. 2, 2006. This application also claims benefit of priority under 35 U.S.C. §119(e) from U.S. Provisional Application Ser. No. 60/911,179, filed Apr. 11, 2007. This application also claims benefit of priority under 35 U.S.C. §119(e) from U.S. Provisional Application Ser. No. 60/797,973, filed May 5, 2006. The contents of all of the aforementioned applications are hereby expressly incorporated by reference in their entirety and for all purposes.

### FIELD OF THE INVENTION

The present invention relates to systems for converting waste residue materials to an inert slag, and in particular to systems for the plasma assisted conversion of residual materials to an inert slag and a gas having a heating value.

### BACKGROUND OF THE INVENTION

Gasification is a process that enables the conversion of carbonaceous feedstock, such as municipal solid waste (MSW) or coal, into a combustible gas. The gas can be used to generate electricity, steam or as a basic raw material to produce chemicals and liquid fuels.

Possible uses for the gas include: the combustion in a boiler for the production of steam for internal processing and/or other external purposes, or for the generation of electricity through a steam turbine; the combustion directly in a gas turbine or a gas engine for the production of electricity; fuel cells; the production of methanol and other liquid fuels; as a further feedstock for the production of chemicals such as plastics and fertilizers; the extraction of both hydrogen and carbon monoxide as discrete industrial fuel gases; and other industrial applications.

Generally, the gasification process consists of feeding carbonaceous feedstock into a heated chamber (the gasifier) along with a controlled and/or limited amount of oxygen and optionally steam. In contrast to incineration or combustion, which operate with excess oxygen to produce CO₂, H₂O, SOₓ, and NOx, gasification processes produce a raw gas composition comprising CO, H₂, H₂S, and NH₃. After clean-up, the primary gasification products of interest are H₂ and CO.

Useful feedstock can include any municipal waste, waste produced by industrial activity and biomedical waste, sewage, sludge, coal, heavy oils, petroleum coke, heavy refinery residuals, refinery wastes, hydrocarbon contaminated soils, biomass, and agricultural wastes, tires, and other hazardous waste. Depending on the origin of the feedstock, the volatiles may include H₂O, H₂, N₂, O₂, CO₂, CO, CH₄, H₂S, NH₃, C₂H₆, unsaturated hydrocarbons such as acetylenes, olefins, aromatics, tars, hydrocarbon liquids (oils) and char (carbon black and ash).

As the feedstock is heated, water is the first constituent to evolve. As the temperature of the dry feedstock increases, pyrolysis takes place. During pyrolysis the feedstock is thermally decomposed to release tars, phenols, and light volatile hydrocarbon gases while the feedstock is converted to char.

Char comprises the residual solids consisting of organic and inorganic materials. After pyrolysis, the char has a higher concentration of carbon than the dry feedstock and may serve as a source of activated carbon. In gasifiers operating at a high temperature (>1,200° C.) or in systems with a high temperature zone, inorganic mineral matter is fused or vitrified to form a molten glass-like substance called slag.

Since the slag is in a fused, vitrified state, it is usually found to be non-hazardous and may be disposed of in a landfill as a non-hazardous material, or sold as an ore, road-bed, or other construction material. It is becoming less desirable to dispose of waste material by incineration because of the extreme waste of fuel in the heating process and the further waste of disposing, as a residual waste, material that can be converted into a useful syngas and solid material.

The means of accomplishing a gasification process vary in many ways, but rely on four key engineering factors: the atmosphere (level of oxygen or air or steam content) in the gasifier; the design of the gasifier; the internal and external heating means; and the operating temperature for the process. Factors that affect the quality of the product gas include: feedstock composition, preparation and particle size; gasifier heating rate; residence time; the plant configuration including whether it employs a dry or slurry feed system, the feedstock-reactant flow geometry, the design of the dry ash or slag mineral removal system; whether it uses a direct or indirect heat generation and transfer method; and the syngas cleanup system. Gasification is usually carried out at a temperature in the range of about 650° C. to 1200° C., either under vacuum, at atmospheric pressure or at pressures up to about 100 atmospheres.

There are a number of systems that have been proposed for capturing heat produced by the gasification process and utilizing such heat to generate electricity, generally known as combined cycle systems.

The energy in the product gas coupled with substantial amounts of recoverable sensible heat produced by the process and throughout the gasification system can generally produce sufficient electricity to drive the process, thereby alleviating the expense of local electricity consumption. The amount of electrical power that is required to gasify a ton of a carbonaceous feedstock depends directly upon the chemical composition of the feedstock.

If the gas generated in the gasification process comprises a wide variety of volatiles, such as the kind of gas that tends to be generated in a low temperature gasifier with a “low quality” carbonaceous feedstock, it is generally referred to as off-gas. If the characteristics of the feedstock and the conditions in the gasifier generate a gas in which CO and H₂ are the predominant chemical species, the gas is referred to as syngas. Some gasification facilities employ technologies to convert the raw off-gas or the raw syngas to a more refined gas composition prior to cooling and cleaning through a gas quality conditioning system.

Utilizing plasma heating technology to gasify a material is a technology that has been used commercially for many years. Plasma is a high temperature luminous gas that is at least partially ionized, and is made up of gas atoms, gas ions, and electrons. Plasma can be produced with any gas in this manner. This gives excellent control over chemical reactions in the plasma as the gas might be neutral (for example, argon, helium, neon), reductive (for example, hydrogen, methane, ammonia, carbon monoxide), or oxidative (for example, oxygen, carbon dioxide). In the bulk phase, a plasma is electrically neutral.

Some gasification systems employ plasma heat to drive the gasification process at a high temperature and/or to refine the offgas/syngas by converting, reconstituting, or reforming longer chain volatiles and tars into smaller molecules with or without the addition of other inputs or reactants when gaseous molecules come into contact with the plasma heat, they will disassociate into their constituent atoms. Many of these atoms will react with other input molecules to form new molecules, while others may recombine with themselves. As the temperature of the molecules in contact with the plasma heat decreases all atoms fully recombine. As input gases can be controlled stoichiometrically, output gases can be controlled to, for example, produce substantial levels of carbon monoxide and insubstantial levels of carbon dioxide.

The very high temperatures (3000 to 7000° C.) achievable with plasma heating enable a high temperature gasification process where virtually any input feedstock including waste in as-received condition, including liquids, gases, and solids in any form or combination can be accommodated. The plasma technology can be positioned within a primary gasification chamber to make all the reactions happen simultaneously (high temperature gasification), can be positioned within the system to make them happen sequentially (low temperature gasification with high temperature refinement), or some combination thereof.

The gas produced during the gasification of carbonaceous feedstock is usually very hot but may contain small amounts of unwanted compounds and requires further treatment to convert it into a useable product. Once a carbonaceous material is converted to a gaseous state, undesirable substances such as metals, sulfur compounds and ash may be removed from the gas. For example, dry filtration systems and wet scrubbers are often used to remove particulate matter and acid gases from the gas produced during gasification. A number of gasification systems have been developed which include systems to treat the gas produced during the gasification process.

These factors have been taken into account in the design of various different systems which are described, for example, in U.S. Pat. Nos. 6,686,556, 6,630,113, 6,380,507; 6,215,678, 5,666,891, 5,798,497, 5,756,957, and U.S. Patent Application Nos. 2004/0251241, 2002/0144981. There are also a number of patents relating to different technologies for the gasification of coal for the production of synthesis gases for use in various applications, including U.S. Pat. Nos. 4,141,694; 4,181,504; 4,208,191; 4,410,336; 4,472,172; 4,606,799; 5,331,906; 5,486,269, and 6,200,430.

Prior systems and processes have not adequately addressed the problems that must be dealt with on a continuously changing basis. Some of these types of gasification systems describe means for adjusting the process of generating a useful gas from the gasification reaction. Accordingly, it would be a significant advancement in the art to provide a system that can efficiently gasify carbonaceous feedstock in a manner that maximizes the overall efficiency of the process, and/or the steps comprising the overall process.

The disposal of solid waste has become a major issue due to space limitations for landfills and the environmental issues that arise. Attempts have been made to reduce the volume and recover the energy content of municipal solid waste (MSW) and other waste through various methods. These methods include incineration in which excess O₂ is added to the input waste so that at low temperature it burns. The result is heat and an exhaust of CO₂, H₂O and other products of combustion or partial combustion. In incineration, as much as 30% of the processed solid waste remains as a solid hazardous waste, ash.

Waste materials such as ash and slag are typically discarded in landfills, however, there is increasing public concern about gaseous emissions from landfills and the possibility of contamination of groundwater. Alternatively, these waste by-products may be processed into cost effective commercial materials and used in many downstream applications, such as sandpaper, glass wool, asphalt, cinder or building blocks, and glass tiles.

U.S. Pat. No. 5,280,757 describes the use of a plasma arc torch in a reactor vessel to gasify municipal solid waste. A product having a medium quality gas and a slag with a lower toxic element leachability is thereby produced.

U.S. Pat. No. 5,666,891 describes an arc plasma-melter electro conversion system for waste treatment and resource recovery. The gas may be utilized in a combustion process to generate electricity and the solid product can be suitable for various commercial applications. The apparatus may additionally be employed without further use of the gases generated by the conversion process.

Accordingly, there remains a need in the art for a system for converting the by-products of carbonaceous feedstock gasification or incineration processes, into a safe, stable form for commercial use or which does not require special hazardous waste considerations for disposal, while also maximizing the recovery of gases having heating value.

### SUMMARY OF THE INVENTION

This invention provides a system for the conversion of residual matter of a carbonaceous feedstock gasification or incineration process into an inert slag product and a gas having a heating value. In particular, the system comprises a refractory-lined residue conditioning chamber comprising a residue inlet, a gas outlet, a slag outlet, a plasma heat source port, and a control system for monitoring operating parameters and adjusting operating conditions within the conversion system to optimize the conversion reaction. The plasma heat causes the residue to melt, and converts carbon present in the residue to a residue gas, which exits the chamber through the gas outlet, and optionally into a gas conditioning subsystem for cooling and conditioning as required for downstream considerations.

The chamber may also optionally comprise one or more inlets for introducing air (or other oxygen containing additives) into the residue conditioning chamber to control the conditioning process. The chamber may also optionally comprise one or more additive inlets for introducing additives to control the composition of the resulting slag product.

### BRIEF DESCRIPTION OF THE DRAWINGS

Embodiments of the present invention will now be described, by way of example only, by reference to the attached Figures, wherein:

FIG. 1 is a block flow diagram showing the inputs and outputs of a residue conditioning system of the present invention;

FIG. 2 is a block flow diagram showing the inputs, optional inputs and outputs of a residue conditioning system of the present invention;

FIG. 3 is a schematic representation of a typical residue conditioning chamber in accordance with the present invention;

FIG. 4A illustrates a perspective view of one embodiment of a residue conditioning chamber;

FIG. 4B is a cross-sectional view of the embodiment of FIG. 4A;

FIG. 5A is a schematic depiction of a residue conditioning chamber in indirect communication with two residue sources, in accordance with one embodiment of the present invention;

FIG. 5B is a schematic depiction of a residue conditioning chamber in indirect communication with one residue source, in accordance with one embodiment of the present invention;

FIG. 6 illustrates a cross-sectional view of one embodiment of a residue conditioning chamber integrated with a residue conditioning chamber;

FIG. 7 is a partial cross-sectional view of an S-spout type slag outlet, in accordance with one embodiment of the present invention;

FIG. 8 is a partial cross-sectional view of a tiltable slag crucible in a residue conditioning chamber in accordance with one embodiment of the present invention;

FIG. 9 is a partial cross-sectional view of one embodiment of a slag outlet, in accordance with the present invention;

FIG. 10 is a partial cross-sectional view of one embodiment of a slag outlet, in accordance with the present invention;

FIG. 11 is a partial cross-sectional view of one embodiment of a slag outlet, in accordance with the present invention;

FIG. 12 is a partial cross-sectional view of one embodiment of a slag outlet, in accordance with the present invention;

FIG. 13 illustrates one embodiment of a residue conditioning chamber in relation to a gasifier and baghouse, in accordance with one embodiment of the present invention;

FIG. 14 is a cross-sectional view of one embodiment of a residue conditioning chamber, in accordance with one embodiment of the present invention;

FIG. 15 is a perspective view of one embodiment of a residue conditioning chamber, in accordance with one embodiment of the present invention;

FIG. 16 is a cross-sectional view of one embodiment of a residue conditioning chamber in relation to a slag cooling subsystem, in accordance with one embodiment of the present invention;

FIG. 17 is a perspective view of one embodiment of a residue conditioning chamber in relation to a residue gas conditioning subsystem, in accordance with one embodiment of the present invention.

### DETAILED DESCRIPTION OF THE INVENTION

Unless defined otherwise, all technical and scientific terms used herein have the same meaning as commonly understood by one of ordinary skill in the art to which this invention belongs.

The term “residue” generally refers to the residual material produced during processes for the gasification or incineration of carbonaceous feedstocks. These include the solid and semi-solid by-products of the process. Such a residue generally consists of the inorganic, incombustible materials present in carbonaceous materials, such as silicon, aluminum, iron and calcium oxides, as well as a proportion of unreacted or incompletely converted carbon. As such, the residue may include char, ash, and/or any incompletely converted feedstock passed from the gasification chamber. The residue may also include materials recovered from downstream gas quality conditioning processes, for example, solids collected in a gas filtering step, such as that collected in a baghouse filter. The residue may also include solid products of carbonaceous feedstock incineration processes, which may come in the form of incinerator bottom ash and flyash collected in an incinerator's pollution abatement suite.

As used herein, the term (carbonaceous) feedstock can be any carbonaceous material appropriate for gasifying in the present gasification process, and can include, but is not limited to, any waste materials, coal (including low grade, high sulfur coal not suitable for use in coal-fired power generators), petroleum coke, heavy oils, biomass, sewage sludge, sludge from pulp and paper mills and agricultural wastes. Waste materials suitable for gasification include both hazardous and non-hazardous wastes, such as municipal waste, wastes produced by industrial activity (paint sludges, off-spec paint products, spent sorbents), automobile fluff, used tires and biomedical wastes, any carbonaceous material inappropriate for recycling, including non-recyclable plastics, sewage sludge, coal, heavy oils, petroleum coke, heavy refinery residuals, refinery wastes, hydrocarbon contaminated solid waste and biomass, agricultural wastes, tires, hazardous waste, industrial waste and biomass. Examples of biomass useful for gasification include, but are not limited to, waste or fresh wood, remains from fruit, vegetable and grain processing, paper mill residues, straw, grass, and manure

“Residue conditioning” means the conversion of a residue to a vitrified, homogenous slag exhibiting low leachability and a gas having a heating value, wherein the residue is a residual material produced during processes related to the gasification or incineration of carbonaceous feedstocks, as defined above.

“Residue gas” refers to the gases produced during the residue conditioning process. As used herein, the term “sensing element” is defined to describe any element of the system configured to sense a characteristic of a process, a process device, a process input or process output, wherein such characteristic may be represented by a characteristic value useable in monitoring, regulating and/or controlling one or more local, regional and/or global processes of the system. Sensing elements considered within the context of a gasification system may include, but are not limited to, sensors, detectors, monitors, analyzers or any combination thereof for the sensing of process, fluid and/or material temperature, pressure, flow, composition and/or other such characteristics, as well as material position and/or disposition at any given point within the system and any operating characteristic of any process device used within the system. It will be appreciated by the person of ordinary skill in the art that the above examples of sensing elements, though each relevant within the context of a gasification system, may not be specifically relevant within the context of the present disclosure, and as such, elements identified herein as sensing elements should not be limited and/or inappropriately construed in light of these examples.

As used herein, the term “response element” is defined to describe any element of the system configured to respond to a sensed characteristic in order to operate a process device operatively associated therewith in accordance with one or more pre-determined, computed, fixed and/or adjustable control parameters, wherein the one or more control parameters are defined to provide a desired process result. Response elements considered within the context of a gasification system may include, but are not limited to static, pre-set and/or dynamically variable drivers, power sources, and any other element configurable to impart an action, which may be mechanical, electrical, magnetic, pneumatic, hydraulic or a combination thereof, to a device based on one or more control parameters. Process devices considered within the context of a gasification system, and to which one or more response elements may be operatively coupled, may include, but are not limited to, material and/or feedstock input means, heat sources such as plasma heat sources, additive input means, various gas blowers and/or other such gas circulation devices, various gas flow and/or pressure regulators, and other process devices operable to affect any local, regional and/or global process within a gasification system. It will be appreciated by the person of ordinary skill in the art that the above examples of response elements, though each relevant within the context of a gasification system, may not be specifically relevant within the context of the present disclosure, and as such, elements identified herein as response elements should not be limited and/or inappropriately construed in light of these examples.

Overview of the Residue Conditioning System

This invention provides a system for the conversion of a residue into a vitrified substance and a residue gas having a heating value, wherein the residue is obtained from one or more sources generated from a gasification system or an incineration system. The system comprises a refractory-lined residue conditioning chamber comprising: a residue inlet, a residue gas outlet, a slag outlet, and one or more ports for heating devices such as a plasma torch; and a control subsystem for monitoring operating parameters and adjusting operating conditions within the system to optimize the conversion reaction. Sensing elements and response elements are integrated within the system, and the response elements adjust the operating conditions within the system according to the data obtained from the sensing elements.

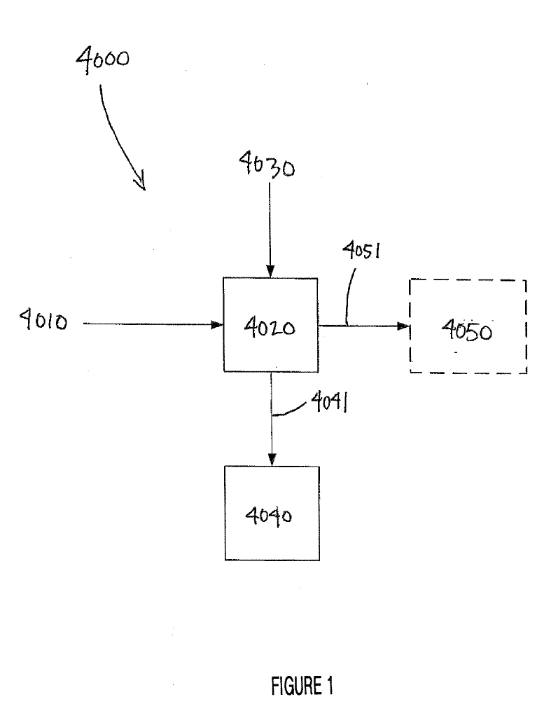

FIG. 1 is a schematic depiction of the representative residue conditioning system, in accordance with one embodiment of the present invention. The residue conditioning system 4000 comprises residue inputs 4010 into a residue conditioning chamber 4020, where plasma heat inputs 4030 convert the residue into a molten slag material 4041 and a residue gas product 4051. The molten slag material 4041 is output from the residue conditioning chamber 4020 and passed into an optional slag cooling subsystem 4040 for cooling. The residue gas 4051 is output from the chamber 4020 and is optionally passed into a gas conditioning subsystem 4050 for cooling and cleaning.

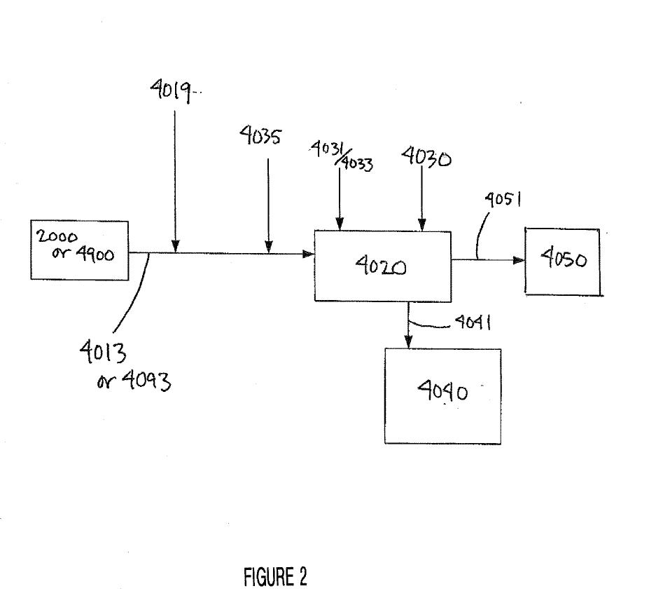

FIG. 2 is a schematic depiction of the representative inputs and outputs of a typical residue conditioning system, including optional inputs, in accordance with one embodiment of the present invention. The residue conditioning system comprises residue inputs that include a residue product 4013 of a carbonaceous feedstock gasifier 2000 or a residue product 4913 of a carbonaceous feedstock incinerator 4900 and an optional secondary residue product 4019 obtained from a particulate matter separation apparatus (e.g., a baghouse filter or cyclone) of a gas conditioning subsystem. These two residues are passed, along with an optional solid process additive 4035 into a residue conditioning chamber 4020, where plasma heat inputs 4030 with optional air additives 4031 and/or steam additives 4033 convert the residue into a molten slag material 4041 and a residue gas 4051. The molten slag material 4051 is output from the residue conditioning chamber 4020 and passed into a slag cooling subsystem 4040 for cooling. The residue gas 4051 is output from the chamber 4020 and passed through residue gas conditioning subsystem 4050.

The present system is suitable for conditioning residue that is, for example, the residual by-products of a carbonaceous feedstock gasification process, or the solids collected in gas conditioning and/or cleanup systems. The residue may also come in the form of incinerator bottom ash and fly ash collected in an incinerator's pollution abatement suite.

The residue conditioning process is accomplished by raising the temperature of the residue to the level required to melt the residue to form a vitreous material that cools to a dense solid. The high temperature also converts carbon in the residue to a residue gas having a heating value. The residue gas produced in the conditioning process exits the chamber via a gas outlet. The gaseous product at this stage typically comprises heavy metal and particulate contaminants. Accordingly, the system optionally comprises a gas conditioning subsystem for cooling and conditioning the residue gas as required for downstream applications.

According to the present invention, the heat required to condition the residue is provided by one or more plasma heat sources. Additional or supplemental heating as may be required can be provided by one or more heating means known in the art including induction heating, joule heating, or a gas burner. Additional heat may also be provided by injecting oxygen or air into the conditioning chamber where the oxygen will react exothermically with carbon and volatiles present in the residue.

The present invention also provides for the addition of air and/or steam as optional gaseous process additives to facilitate the conversion of the carbon to residue gas having a heating value.

The source of the residue may be, but is not limited to, a low temperature or high temperature gasifier, an incinerator, a hopper in which the residue is stored, or particulate matter separators within a gas conditioning system, for example, a baghouse filter or cyclone. The residue conditioning chamber may be directly or indirectly connected to the source of the residue to be conditioned. The residue is conveyed, continuously or intermittently, from the source of the residue through appropriately adapted outlets and/or conveyance means to the residue inlet of the chamber, as would be known to the skilled worker, according to the requirements of the system and the type of by-product to be removed.

The molten slag, at a temperature of, for example, about 1200° C. to about 1800° C., may periodically or continuously be output from the residue chamber and thereafter cooled to form a solid slag material. Such slag material may be intended for landfill disposal or may further be broken into aggregates for conventional uses. Alternatively, the molten slag can be poured into containers to form ingots, bricks tiles or similar construction material. The resulting slag material may also be used as a supplementary cementing material in concrete, in the production of a lightweight aggregate or mineral wool, in the manufacture of foam glass, or in the development of packaging materials. The composition of the resulting slag material may be controlled through the addition of process additives to change melting point and/or other properties of the slag. Such solid process additives may include, but are not limited to silica, alumina, lime or iron.

Accordingly, the present invention also includes a subsystem for cooling the molten slag to its solid form. The slag cooling subsystem is provided as appropriate to afford the cooled slag product in the desired format.

The present invention also provides a control system for managing the residue conditioning process. In particular, the residue conditioning system comprises a control subsystem comprising sensing elements for monitoring operating parameters of the residue conditioning system, and response elements for adjusting operating conditions within the residue conditioning system to manage the conversion process, wherein the response elements adjust the operating conditions within the system according to the data obtained from the sensing elements, thereby promoting efficient and complete melting. The adjustable operating parameters include, for example, plasma heat rate (power) and position, residue feed rate, air and/or steam inputs and system pressure.

Residue Conditioning Chamber

The residue conditioning system of the present invention comprises a residue conditioning chamber which is adapted to i) input the residue to be conditioned, ii) input heat and condition the residue to form a molten slag material and a gaseous product having a heating value, and iii) output the molten slag and gaseous product. Accordingly, the residue conditioning chamber is a refractory-lined chamber comprising a residue inlet, a gas outlet, a slag outlet, and a plasma heat source port. The residue conditioning chamber further optionally includes one or more air and/or steam inlets.

The residue conditioning chamber is designed to ensure that the residue conditioning process is carried out efficiently and completely, in order to use a minimum amount of energy to effect complete conditioning of the residue. Accordingly, factors such as efficient heat transfer, adequate heat temperatures, residence time, molten slag flow, input residue volume and composition, and size and insulation of the chamber are taken into account when designing the residue conditioning chamber. The chamber is also designed to ensure that the residue conditioning process is carried out in a safe manner. Accordingly, the system is designed to isolate the residue conditioning environment from the external environment.

The residue conditioning chamber is provided with a plasma heat source that meets the required temperature for heating the residue to levels required to convert any remaining volatiles and carbon to a gaseous product having a heating value and to melt and homogenize the residue to provide a molten slag at a temperature sufficient to flow out of the chamber. The chamber is also designed to ensure highly efficient heat transfer between the plasma gases and the residue, to minimize the amount of sensible heat that is lost via the product gas. Therefore, the type of plasma heat source used, as well as the position and orientation, of the plasma heating means are additional factors to be considered in the design of the residue conditioning chamber.

The residue conditioning chamber is also designed to ensure that the residue residence time is sufficient to bring the residue up to an adequate temperature for melting and homogenization, and to fully convert the carbon to the gaseous product. Accordingly, the chamber is provided with a reservoir in which the residue accumulates while being heated by the plasma heat source. The reservoir also allows mixing of the solid and molten materials during the conditioning process. Sufficient residence time and adequate mixing ensures that the conditioning process is completely carried out, and that the resulting slag and gaseous products have the desired composition.

The chamber is designed for continuous or intermittent output of the molten slag material. Continuous slag removal allows the conditioning process to be carried out on a continual basis, wherein the residue to be conditioned may be continuously input and processed by the plasma heat, without interruption for periodic slag removal.

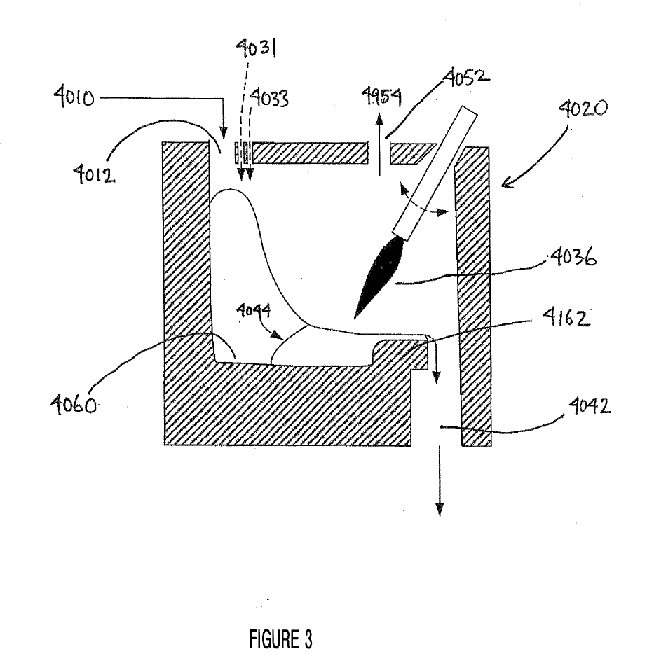

In one embodiment, continuous slag exhaust is achieved by using a reservoir bounded on one side by a weir that allows the slag pool to accumulate until it exceeds a certain level, at which point the molten slag runs over the weir and out of the chamber. In the embodiment depicted in FIG. 3, the residue 4010 drops through a residue inlet 4012 located at the top of the conditioning chamber 4020 into a reservoir 4060, where it is conditioned by a plasma torch plume 4036. The molten materials are held in the reservoir 4060 by a weir 4162 until the pool 4044 reaches the top of the weir. Thereafter, as additional residue enters the system and is conditioned, a corresponding amount of molten material overflows the weir and out of the chamber through a slag outlet 4042. A residue gas product 4954 exits the chamber via a gas outlet 4052.

Where the residue being conditioned contains a significant amount of metal, and the residue conditioning chamber comprises a reservoir bounded by a weir, the metals, due to their higher melting temperature and density, typically accumulate in the reservoir until such time as they are removed. Accordingly, in one embodiment of the present invention, the reservoir is optionally provided with a metal tap port, whereby the tap port is plugged with a soft refractory paste, through which a hole may be periodically opened using the heat from an oxygen lance. Once the tap port has been opened and the chamber temperature has been raised sufficiently to melt the accumulated metals, the molten metals are tapped off from the bottom of the reservoir. The outlet is resealed by placing refractory or other suitable material into the hole.

In one embodiment, the reservoir itself may also be provided with a slag outlet adapted for continuous exhaust of the molten slag. In one embodiment, the reservoir may also provide for intermittent slag removal, wherein the reservoir is designed to allow the accumulation of molten materials until the conditioning process is complete, at which point the molten slag is exhausted. Such slag outlet design options will be described in more detail later.

Due to the very high temperatures needed to melt the residue, and particularly to melt any metals that may be present, the residue conditioning chamber wall is lined with a refractory material that will be subjected to very severe operational demands. The selection of appropriate materials for the design of a residue conditioning chamber is made according to a number of criteria, such as the operating temperature that will be achieved during typical residue conditioning processes, resistance to thermal shock, and resistance to abrasion and erosion/corrosion due to the molten slag and/or hot gases that are generated during the conditioning process.

The inner refractory is selected to provide an inner lining having very high resistance to corrosion and erosion, particularly at the slag waterline, in addition to resistance to the high operating temperatures. The porosity and slag wetability of the inner refractory material must be considered to ensure that the refractory material selected will be resistant to penetration of the molten slag into the hot face. The materials are also selected such that secondary reactions of the refractory material with hydrogen are minimized, thereby avoiding a possible loss of integrity in the refractory and contamination of the product gas.

The residue conditioning chamber is typically manufactured with multiple layers of materials as are appropriate. For example, the outer layer, or shell, of the chamber is typically steel. Moreover, it may be beneficial to provide one or more insulating layers between the inner refractory layer and the outer steel shell to reduce the temperature of the steel casing. Where a second layer (for example, an insulating firebrick layer) is provided, it may also be necessary to select a material that does not react with hydrogen. An insulating board around the outer surface of the slag reservoir may also be provided to reduce the temperature of the steel casing. When room for expansion of the refractory without cracking is required, a compressible material, such as a ceramic blanket, can be used against the steel shell. The insulating materials are selected to provide a shell temperature high enough to avoid acid gas condensation if such an issue is relevant, but not so high as to compromise the integrity of the outer shell.

The refractory material can therefore be one, or a combination of, conventional refractory materials known in the art which are suitable for use in a chamber for extremely high temperature (e.g., a temperature of about 1100° C. to 1800° C.) non-pressurized reaction. Examples of such refractory materials include, but are not limited to, high temperature fired ceramics (such as aluminum oxide, aluminum nitride, aluminum silicate, boron nitride, chromium oxide, zirconium phosphate), glass ceramics and high alumina brick containing principally, silica, alumina and titania.

Due to the severe operating conditions, it is anticipated that the reservoir refractory will require periodic maintenance. Accordingly, in one embodiment, the residue conditioning chamber is provided in separable upper and lower portions, wherein the chamber lower portion (where the reservoir is located) is removable from the chamber upper portion. In one embodiment, the chamber is suspended from a support structure such that the lower portion can be dropped away from the upper portion to facilitate maintenance. This embodiment provides for removing the lower portion without disturbing any connections between the chamber upper portion and upstream or downstream components of the system.

The residue conditioning chamber may also include one or more ports to accommodate additional structural elements or instruments that may optionally be required. In one embodiment, the port may be a viewport that optionally includes a closed circuit television to maintain operator full visibility of aspects of the residue processing, including monitoring of the slag outlet for formation of blockages. The chamber may also include service ports to allow for entry or access into the chamber for maintenance and repair. Such ports are known in the art and can include sealable port holes of various sizes.

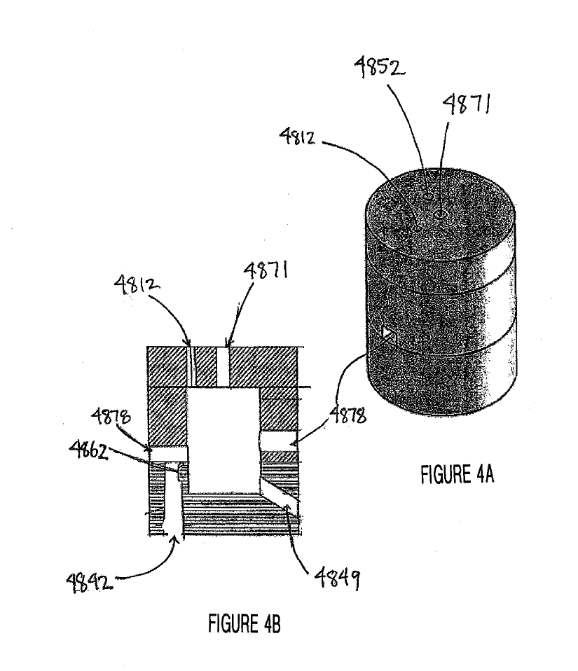

In one embodiment, the residue conditioning chamber may be tubular in shape, as depicted in FIGS. 4A and 4B. This embodiment comprises a torch mounting port 4871, a residue inlet 4812, a reservoir 4860 bounded on one side by a weir 4862, a gas outlet 4852, a slag outlet 4842, a metal tap port 4849 and view ports 4878.

Residue Input

The system of the present invention comprises a residue input means in association with the residue inlet of the conditioning chamber. The residue inlet is adapted to receive the residue into the residue conditioning chamber. The residue input means conveys the residue from a source of the residue material to the inlet of the conditioning chamber. Residue material entering the chamber may come from one or multiple sources. Sources of the residue may include, but are not limited to, a low temperature or high temperature gasifier, an incinerator, a hopper in which the residue is stored, or upstream gas conditioning systems, for example, a baghouse filter.

Where the residue to be conditioned is provided in more than one input stream, or from more than one source, the different streams may each be passed into the conditioning chamber through a dedicated residue inlet, or they may be combined prior to introduction into the residue conditioning chamber. In the latter embodiment, there is provided one residue inlet through which all residues are provided. Accordingly, the chamber may comprise a common inlet or multiple inlets to cater to any physical characteristics of the input residue material.

The source of the residue may be provided in direct communication with the conditioning chamber, i.e., each residue input is fed directly from the source into the residue conditioning chamber. Alternatively, the source may be provided in indirect communication with the residue conditioning chamber, wherein the residue inputs are conveyed from the source into the residue conditioning chamber via a system of conveyor means.

Where the residue conditioning chamber is indirectly connected to the source of the residue, the residue input means comprises one or more means for conveying the residue from the source into the residue conditioning chamber. For example, the residue input means may include a single screw conveyor or a series of screw conveyors.

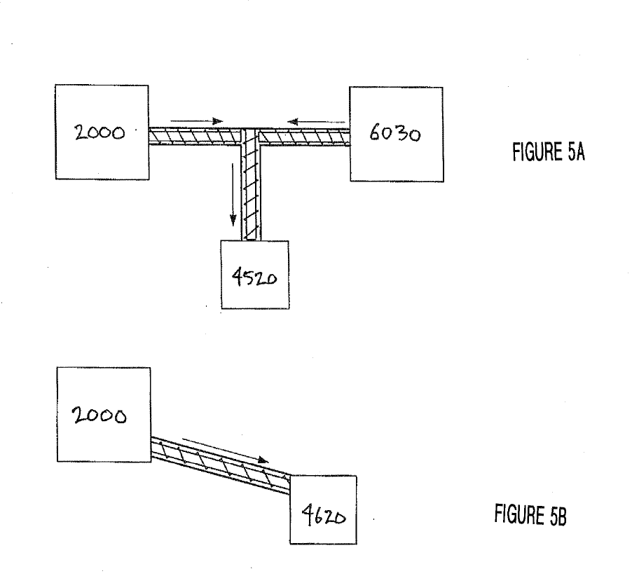

In one embodiment, the residue conditioning chamber is provided to condition the by-products of a carbonaceous feedstock gasification process. In such an embodiment, the residue sources may include the gasifier, as well as the baghouse filter of any gas conditioning system(s) associated with the gasification process. FIG. 5A is a schematic depiction of one embodiment of a residue conditioning chamber 4520 indirectly connected to two sources of residue to be conditioned, where one source is a carbonaceous feedstock gasifier 2000, and the other source is baghouse filter 6030 of a gas conditioning subsystem. FIG. 5B is a schematic depiction of one embodiment of a residue conditioning chamber 4620 indirectly connected to one source of residue to be conditioned, where the source is a carbonaceous feedstock gasifier 2000.

In embodiments wherein the residue conditioning chamber is directly connected to the source of the residue, the residue source and residue conditioning chamber employed may be the same as those of the indirectly connected embodiment, with the exception that the source of residue communicates directly with conditioning chamber, without the need for an intermediate conveying means. In this arrangement the residue passes directly from the source of residue into the adjoining (and integral) residue conditioning chamber. In such a “contiguous” embodiment, the residue may be conveyed actively or passively (i.e., by gravity) from the residue source into the chamber.

In directly connected (or contiguous) embodiments where the residue is actively conveyed into the residue conditioning chamber, the residue input means is typically located within the residue source. Such conveyance means may include screw conveyors, rotating arms, rotating chains, traveling grates and pusher rams.

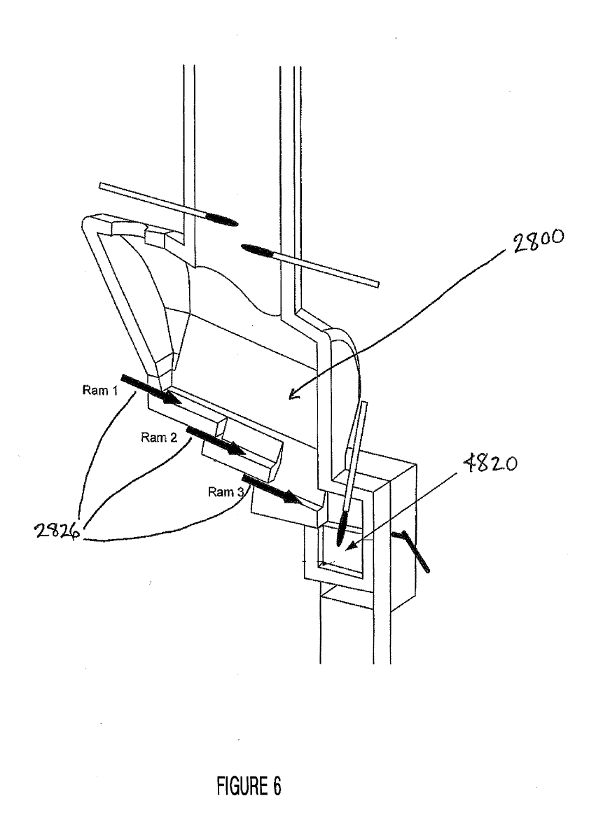

FIG. 6 depicts one embodiment of the present invention in which a gasifier 2800 is provided in direct communication with a residue conditioning chamber 4820. In this embodiment, the residue input means comprises a series of pusher rams 2826.

The residue input means optionally include a control mechanism such that the input rate of the residue can be controlled to ensure optimal melting and homogenization of the residue material.

In one embodiment of the invention, solid process additives are added to the residue to be conditioned in order to adjust the composition of the slag product. These solid process additives may be added to the residue prior to introduction into the residue conditioning chamber, or they may be added directly to the residue conditioning chamber through a dedicated additive inlet. In one embodiment, the solid process additive is added directly to the conditioning chamber via a dedicated additive feed inlet. In one embodiment, the additive is introduced to the residue prior to introduction to the conditioning chamber.

Where the residue conditioning system is associated with a carbonaceous feedstock gasification process, it is also possible to add the solid process additive to the feedstock prior to gasification.

Plasma Heat

The system of the present invention employs one or more plasma heating sources to convert the residue material produced by the upstream processes. The plasma heat sources may be movable, fixed or a combination thereof.

The plasma heat sources may comprise a variety of commercially available plasma torches that provide suitably high flame temperatures for sustained periods at the point of application. In general, such plasma torches are available in sizes from about 100 kW to over 6 MW in output power. The plasma torch can employ one or a combination of suitable working gases. Examples of suitable working gases include, but are not limited to, air, argon, helium, neon, hydrogen, methane, ammonia, carbon monoxide, oxygen, nitrogen, and carbon dioxide. In one embodiment of the present invention, the plasma heating means is continuously operating so as to produce a temperature in excess of about 900° C. to about 1800° C. as required for converting the residue material to the inert slag product.

In this respect, a number of alternative plasma technologies are suitable for use in the present system. For example, it is understood that transferred arc and non-transferred arc torches (both AC and DC), using appropriately selected electrode materials, may be employed. It is also understood that inductively coupled plasma torches (ICP) may also be employed. Selection of an appropriate plasma heat source is within the ordinary skills of a worker in the art.

The use of transferred arc torches instead of non-transferred arc torches may improve the efficiency of the residue conditioning process due to their higher electrical to thermal efficiency, as well as the higher heat transfer efficiency between the hot plasma gases and the material being melted because the arc passes directly through the melt. Where transferred arc torches are used, it is necessary to ensure that the conditioning chamber is electrically isolated since the chamber outer shell will be electrically connected to the power supply.

In one embodiment, the plasma heat source is a DC non-transferred arc torch.

In one embodiment of the present invention, the one or more plasma heat sources are positioned to optimize the conversion of the residue material to inert slag. The position of the plasma heat source(s) is selected according to the design of the residue conditioning chamber. For example, where a single plasma heat source is employed, the plasma heat source may be mounted in the top of the chamber and disposed in a position relative to the slag pool collecting at the bottom of the chamber to ensure sufficient heat exposure to melt the residue material and force the slag to flow. In one embodiment, the plasma heat source is a plasma torch vertically mounted in the top of the chamber.

All plasma heat sources are controllable for power and optionally (where movable heat sources are used) position. In one embodiment, the plasma heat rate is varied to accommodate varying residue input rate. The plasma heat rate can also be varied to accommodate varying residue melting temperature properties.

The plasma heat sources may be operated on a continuous or non-continuous basis at the discretion of the operator to accommodate varying residue input rate and melting temperature properties.

Air and Steam Inputs

The residue being conditioned will typically contain a proportion of unreacted or unconverted carbon. Accordingly, air and/or steam may optionally be added to the residue conditioning chamber to ensure complete conversion of the carbon, as required by the varying carbon content of the residue material being conditioned. Since the carbon reacts with oxygen in an exothermic reaction, air inputs may also be used and adjusted to maintain optimum processing temperatures while minimizing the cost of plasma heat required in the conditioning process. As such, the amount of air injection is maintained to ensure the maximum conversion of carbon to carbon monoxide with the minimum plasma heat requirement to carry out the process.

If the temperature within the conditioning chamber is too high and/or the gaseous product of the conditioning process has a high carbon particle (soot) content, steam can be injected to control the temperature and/or convert the solid carbon to carbon monoxide and hydrogen.

The chamber, therefore, can include one or more air input ports for air injection, and optionally one or more steam input ports for steam injection. The air and steam input ports are strategically located in and around the residue conditioning chamber to ensure full coverage of the air and steam inputs into the chamber.

Slag Output

The system of the present invention comprises a slag output means in association with the conditioning chamber. The slag output means includes an outlet on the residue conditioning chamber through which molten slag is exhausted. The outlet is typically located at or near the bottom of the chamber to facilitate the gravity flow of the molten slag pool out of the chamber. The slag output means also includes a slag cooling subsystem to facilitate the cooling of the molten slag to it solid form.

The molten slag can be extracted in a continuous manner throughout the full duration of processing. The molten slag can also be extracted from the chamber intermittently, e.g., through a batch pour or periodic exhausting at the end of a processing period. The molten slag from either method can be cooled and collected in a variety of ways that will be apparent to a person skilled in the art, to form a dense, non-leachable, solid slag. The slag output means may further be adapted to minimize heating requirements and to avoid contact of the product gas with external air by keeping the residue conditioning chamber sealed.

According to the present invention, as the residue is conditioned by the plasma heat, the resulting molten slag accumulates in a reservoir.

As discussed previously, in the embodiments of the invention depicted in FIGS. 3, 4A and 4B, the molten slag is extracted in a continuous manner, i.e., as the volume of molten slag in the reservoir increases, it passes over a weir and exits the conditioning chamber through an outlet.

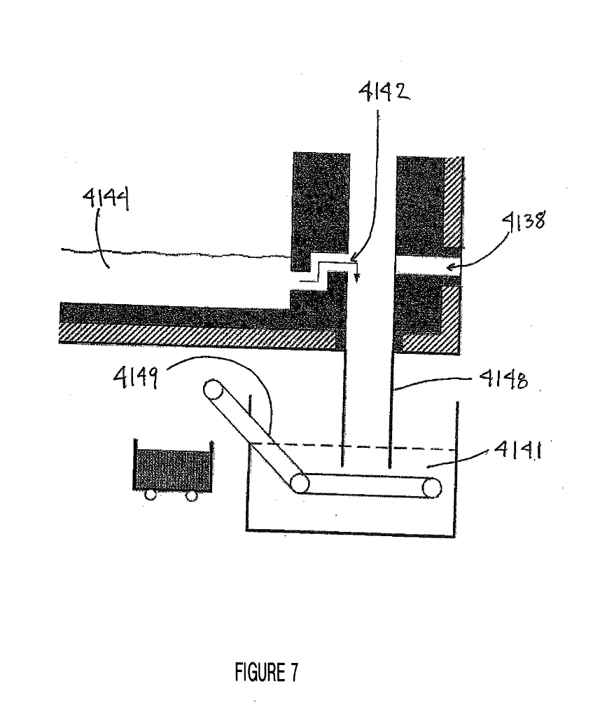

In one embodiment of the residue conditioning chamber, as depicted in FIG. 7, the molten slag is exhausted through an S-trap outlet 4142. In this embodiment, the slag output means may optionally comprise a burner 4138 or other heating means located at or near the outlet 4142 in order to maintain the temperature of the molten slag at the outlet 4142 high enough to ensure that the outlet 4142 remains open through the complete slag extraction period. This embodiment also ensures that the level of the slag pool 4144 does not go below a predetermined level, thereby keeping the melt environment sealed to avoid gaseous contact with the external environment.

Continuous pour embodiments are particularly suitable for systems that are designed to operate on a continuous basis, for example, where the residue conditioning system is provided in association with a continuous feedstock gasification facility.

In one embodiment, the molten slag accumulates in a reservoir until the reservoir is periodically emptied. In such an embodiment, the reservoir may be emptied by a tipping mechanism, or through an outlet in the reservoir as may be provided to controllably exhaust the molten slag.

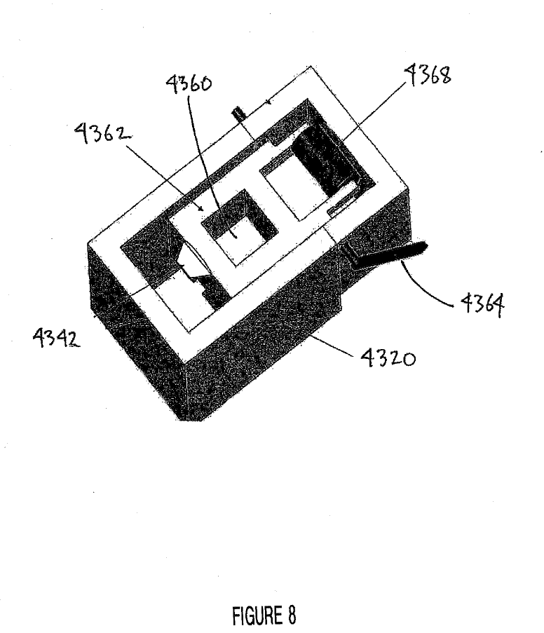

FIG. 8 illustrates one embodiment that may be provided to controllably exhaust the molten slag from a reservoir by a tipping mechanism. In this embodiment, the residue conditioning chamber 4320 has a tiltable crucible 4362 comprising reservoir 4360, a spout 4342, a counterweight 4368 and a lever arm 4364 provided as a mechanism for tilting the crucible 4362.

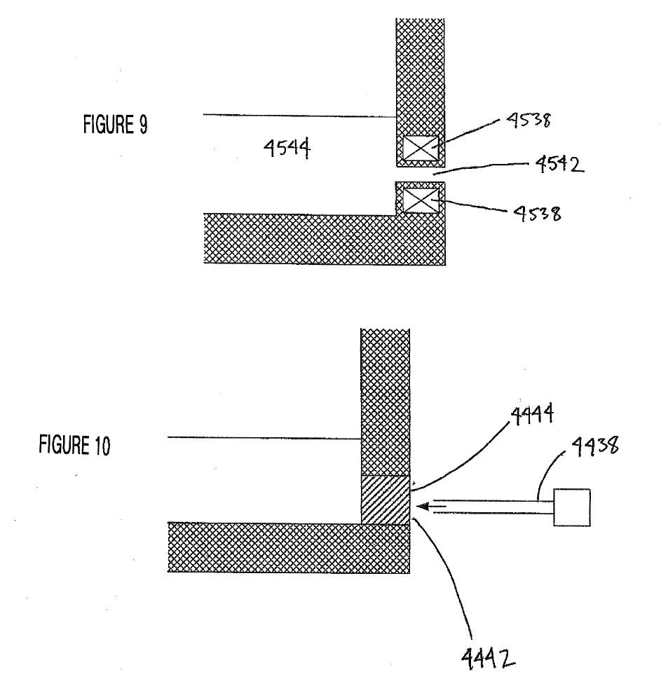

FIGS. 9 to 12 schematically illustrate portions of different design options that may be provided for controlled exhaust of the molten slag through an appropriately adapted outlet in the reservoir or chamber. The molten slag exhaust may be controlled to ensure that the level of the molten slag is not allowed to reach below the top of the outlet, so that gases from the external atmosphere do not enter the interior melt region.

FIG. 9 depicts a reservoir or chamber having an outlet 4542 in a side wall near the bottom of the reservoir/chamber. The outlet 4542 is surrounded by an induction heater 4538 enclosed in the refractory that can control the temperature of the refractory in the region surrounding the outlet 4542. Increasing the temperature sufficiently to maintain the slag in the molten state allows the slag to flow though the outlet 4542. When the level of the slag pool 4544 reaches the desired level, the induction heater 4538 is turned off, and the slag is allowed to solidify in the outlet 4542.

FIG. 10 depicts one embodiment wherein the outlet 4442 is “plugged” with a soft refractory paste 4444. An oxygen lance 4438 is provided in a position suitable to “burn” a hole into the soft refractory paste 4444 allowing molten slag to pour out. The flow is stopped by placing refractory or other suitable material back into the outlet 4442.

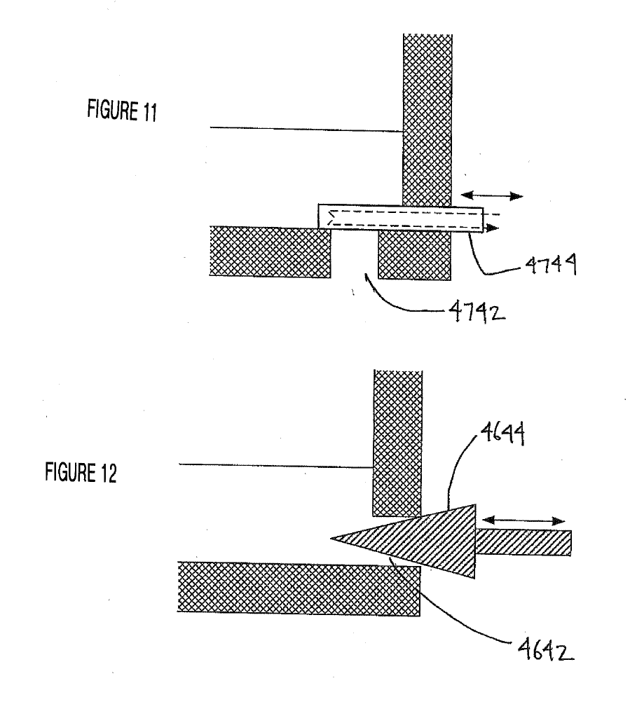

FIG. 11 depicts one embodiment wherein the outlet 4742 is covered by a movable water cooled plug 4744. The plug 4744 is movable from a closed position to an open position, thereby exposing the outlet 4742 to allow the molten slag to exhaust through the outlet 4742. The molten material should not adhere to the smooth surface of the plug 4744 because of the water cooling effect.

FIG. 12 depicts one embodiment wherein the outlet 4642 is plugged by a wedge-type device 4644. The “wedge” is pushed in and out of outlet 4642 as required to control the exhaust of the molten slag.

In one embodiment, the slag output means also comprises a slag cooling subsystem for cooling the molten slag to provide a solid slag product. In one embodiment, schematically depicted in FIG. 7, the molten slag is poured into a quench water bath 4141. The water bath 4141 provides an efficient system for cooling the slag and causing it to shatter into granules suitable for commercial uses, such as for the manufacture of concrete or for road building. The water bath 4141 may also provide a seal to the environment in the form of a shroud 4148 that extends from the base of the slag chamber down into the water bath, thereby providing a barrier preventing outside gases from entering the residue conditioning chamber. The solid slag product may be removed from the water bath 4141 by a conveyor system 4149.

In one embodiment of the slag cooling subsystem, the molten slag is dropped into a thick walled steel catch container for cooling. In one embodiment, the molten slag is received in an environmentally sealed bed of silica sand or into moulds to provide solid slag suitable for small scale processing or for testing certain parameters whenever such testing is performed. The small moulds can be control cooled in a preheated oven.

In one embodiment of the slag cooling subsystem, the molten slag is converted to a commercial product such as glass wool.

Where the residue conditioning system is provided to condition the residue remaining after the gasification of a material that contains a significant amount of metals, such as municipal solid waste, it is likely that a proportion of the metal will be passed through the gasification system and into the residue conditioning chamber. These metals will not necessarily melt at the normal slag vitrification temperature, therefore, the slag reservoir could become clogged with metal over time as it is of higher density than the molten slag. In order to remove accumulated metals, the chamber temperature may be periodically raised to melt any metals and the molten metals may be tapped off from the bottom of the reservoir through a metal tap port as required. FIG. 4B depict one embodiment of a conditioning chamber comprising such a metal tap port 4849.

Residue Gas Outlet

Where the residue being conditioned contains a proportion of unreacted carbon, a product of the residue conditioning process will be a gas having a potentially useful heating value, and may be appropriate for uses in downstream applications. This gas is referred to herein as “residue gas”.

Gases that are produced in the residue conditioning chamber during conversion of the residue material to inert slag exit the chamber via a gas outlet. The residue gas may then be further treated in gas cooling and/or pollution abatement systems known in the art.

Accordingly, in one embodiment of the invention, the residue gas is directed to a system provided for cooling and cleaning the gas, which is referred to as a “residue gas conditioning system”. The residue gas conditioning subsystem typically comprises means for cooling the gas, as well as means for removing particulate matter and heavy metal contaminants. After the residue gas has been treated, it is ready for use in downstream applications.

Where the residue conditioning chamber is a component of a gasification system having a gas conditioning system for cooling and cleaning the gaseous product of the gasification process, the treated residue gas may be combined with the main gasification gas product stream for use in downstream applications. In one embodiment, the cleaned and conditioned residue gas stream is diverted back to the main gas conditioning system, where it joins the main gas stream.

The use of a dedicated residue gas conditioning system to treat the residue gas prior to its introduction to the main product gas stream provides for the removal of any heavy metals or particulate matter that may be present, thereby minimizing the amount of heavy metals or particulate matter that will be passed through the main gas conditioning system.

In one embodiment, any material accumulating in the residue gas conditioning subsystem may be directed back to the residue conditioning chamber of the present invention for further conditioning. Material from the residue gas conditioning subsystem may also be disposed of in a hazardous waste disposal. The quantity of residue removed from the baghouse of the residue gas conditioner is typically less than that removed from the baghouse in the main gas conditioner.

In one embodiment of the residue gas conditioning subsystem, the residue gas is passed through a residue gas conditioner baghouse filter to remove particulates and a proportion of the heavy metal contaminants. The residue gas is then cooled using a heat exchanger before it is passed through an activated carbon bed for the further removal of heavy metals and particulate matter. In one embodiment, the residue gas undergoes a pre-cooling step in an indirect air-to-gas heat exchanger prior to being passed through the baghouse filter.

The Control System

The system of the present invention comprises a control system for use with the residue conditioning system to regulate the efficient and complete conversion of the residue into an inert slag product and a residue gas having a heating value.

In one embodiment of the present invention, a control system may be provided to control one or more processes implemented in, and/or by, the various systems and/or subsystems disclosed herein, and/or provide control of one or more process devices contemplated herein for affecting such processes. In general, the control system may operatively control various local and/or regional processes related to a given system, subsystem or component thereof, and/or related to one or more global processes implemented within a system, such as a gasification system, within or in cooperation with which the various embodiments of the present invention may be operated, and thereby adjusts various control parameters thereof adapted to affect these processes for a defined result. Various sensing elements and response elements may therefore be distributed throughout the controlled system(s), or in relation to one or more components thereof, and used to acquire various process, reactant and/or product characteristics, compare these characteristics to suitable ranges of such characteristics conducive to achieving the desired result, and respond by implementing changes in one or more of the ongoing processes via one or more controllable process devices.

The control system generally comprises, for example, one or more sensing elements for sensing one or more characteristics related to the system(s), process(es) implemented therein, input(s) provided therefor, and/or output(s) generated thereby. One or more computing platforms are communicatively linked to these sensing elements for accessing a characteristic value representative of the sensed characteristic(s), and configured to compare the characteristic value(s) with a predetermined range of such values defined to characterise these characteristics as suitable for selected operational and/or downstream results, and compute one or more process control parameters conducive to maintaining the characteristic value with this predetermined range. A plurality of response elements may thus be operatively linked to one or more process devices operable to affect the system, process, input and/or output and thereby adjust the sensed characteristic, and communicatively linked to the computing platform(s) for accessing the computed process control parameter(s) and operating the process device(s) in accordance therewith.

In one embodiment, the control system provides a feedback, feedforward and/or predictive control of various systems, processes, inputs and/or outputs related to the conversion of carbonaceous feedstock into a gas, so to promote an efficiency of one or more processes implemented in relation thereto. For instance, various process characteristics may be evaluated and controllably adjusted to influence these processes, which may include, but are not limited to, the heating value and/or composition of the feedstock, the characteristics of the product gas (e.g. heating value, temperature, pressure, flow, composition, carbon content, etc.), the degree of variation allowed for such characteristics, and the cost of the inputs versus the value of the outputs. Continuous and/or real-time adjustments to various control parameters, which may include, but are not limited to, heat source power, additive feed rate(s) (e.g. oxygen, oxidants, steam, etc.), feedstock feed rate(s) (e.g. one or more distinct and/or mixed feeds), gas and/or system pressure/flow regulators (e.g. blowers, relief and/or control valves, flares, etc.), and the like, can be executed in a manner whereby one or more process-related characteristics are assessed and optimized according to design and/or downstream specifications.

Alternatively, or in addition thereto, the control system may be configured to monitor operation of the various components of a given system for assuring proper operation, and optionally, for ensuring that the process(es) implemented thereby are within regulatory standards, when such standards apply.

In accordance with one embodiment, the control system may further be used in monitoring and controlling the total energetic impact of a given system. For instance, a given system may be operated such that an energetic impact thereof is reduced, or again minimized, for example, by optimising one or more of the processes implemented thereby, or again by increasing the recuperation of energy (e.g. waste heat) generated by these processes. Alternatively, or in addition thereto, the control system may be configured to adjust a composition and/or other characteristics (e.g. temperature, pressure, flow, etc.) of a product gas generated via the controlled process(es) such that such characteristics are not only suitable for downstream use, but also substantially optimised for efficient and/or optimal use. For example, in an embodiment where the product gas is used for driving a gas engine of a given type for the production of electricity, the characteristics of the product gas may be adjusted such that these characteristics are best matched to optimal input characteristics for such engines.

In one embodiment, the control system may be configured to adjust a given process such that limitations or performance guidelines with regards to reactant and/or product residence times in various components, or with respect to various processes of the overall process are met and/or optimised for. For example, an upstream process rate may be controlled so to substantially match one or more subsequent downstream processes.

In addition, the control system may, in various embodiments, be adapted for the sequential and/or simultaneous control of various aspects of a given process in a continuous and/or real time manner.

In general, the control system may comprise any type of control system architecture suitable for the application at hand. For example, the control system may comprise a substantially centralized control system, a distributed control system, or a combination thereof. A centralized control system will generally comprise a central controller configured to communicate with various local and/or remote sensing devices and response elements configured to respectively sense various characteristics relevant to the controlled process, and respond thereto via one or more controllable process devices adapted to directly or indirectly affect the controlled process. Using a centralized architecture, most computations are implemented centrally via a centralized processor or processors, such that most of the necessary hardware and/or software for implementing control of the process is located in a same location.

A distributed control system will generally comprise two or more distributed controllers which may each communicate with respective sensing and response elements for monitoring local and/or regional characteristics, and respond thereto via local and/or regional process devices configured to affect a local process or sub-process. Communication may also take place between distributed controllers via various network configurations, wherein a characteristics sensed via a first controller may be communicated to a second controller for response thereat, wherein such distal response may have an impact on the characteristic sensed at the first location. For example, a characteristic of a downstream product gas may be sensed by a downstream monitoring device, and adjusted by adjusting a control parameter associated with the converter that is controlled by an upstream controller. In a distributed architecture, control hardware and/or software is also distributed between controllers, wherein a same but modularly configured control scheme may be implemented on each controller, or various cooperative modular control schemes may be implemented on respective controllers.

Alternatively, the control system may be subdivided into separate yet communicatively linked local, regional and/or global control subsystems. Such an architecture could allow a given process, or series of interrelated processes to take place and be controlled locally with minimal interaction with other local control subsystems. A global master control system could then communicate with each respective local control subsystems to direct necessary adjustments to local processes for a global result.

The control system of the present invention may use any of the above architectures, or any other architecture commonly known in the art, which are considered to be within the general scope and nature of the present disclosure. For instance, processes controlled and implemented within the context of the present invention may be controlled in a dedicated local environment, with optional external communication to any central and/or remote control system used for related upstream or downstream processes, when applicable. Alternatively, the control system may comprise a sub-component of a regional and/or global control system designed to cooperatively control a regional and/or global process. For instance, a modular control system may be designed such that control modules interactively control various sub-components of a system, while providing for inter-modular communications as needed for regional and/or global control.

The control system generally comprises one or more central, networked and/or distributed processors, one or more inputs for receiving current sensed characteristics from the various sensing elements, and one or more outputs for communicating new or updated control parameters to the various response elements. The one or more computing platforms of the control system may also comprise one or more local and/or remote computer readable media (e.g. ROM, RAM, removable media, local and/or network access media, etc.) for storing therein various predetermined and/or readjusted control parameters, set or preferred system and process characteristic operating ranges, system monitoring and control software, operational data, and the like. Optionally, the computing platforms may also have access, either directly or via various data storage devices, to process simulation data and/or system parameter optimization and modeling means. Also, the computing platforms may be equipped with one or more optional graphical user interfaces and input peripherals for providing managerial access to the control system (system upgrades, maintenance, modification, adaptation to new system modules and/or equipment, etc.), as well as various optional output peripherals for communicating data and information with external sources (e.g. modem, network connection, printer, etc.).

The processing system and any one of the sub-processing systems can comprise exclusively hardware or any combination of hardware and software. Any of the sub-processing systems can comprise any combination of none or more proportional (P), integral (I) or differential (D) controllers, for example, a P-controller, an I-controller, a PI-controller, a PD controller, a PID controller etc. It will be apparent to a person skilled in the art that the ideal choice of combinations of P, I, and D controllers depends on the dynamics and delay time of the part of the reaction process of the gasification system and the range of operating conditions that the combination is intended to control, and the dynamics and delay time of the combination controller. It will be apparent to a person skilled in the art that these combinations can be implemented in an analog hardwired form which can continuously monitor, via sensing elements, the value of a characteristic and compare it with a specified value to influence a respective control element to make an adequate adjustment, via response elements, to reduce the difference between the observed and the specified value. It will further be apparent to a person skilled in the art that the combinations can be implemented in a mixed digital hardware software environment. Relevant effects of the additionally discretionary sampling, data acquisition, and digital processing are well known to a person skilled in the art. P, I, D combination control can be implemented in feed forward and feedback control schemes.

In corrective, or feedback, control the value of a control parameter or control variable, monitored via an appropriate sensing element, is compared to a specified value or range. A control signal is determined based on the deviation between the two values and provided to a control element in order to reduce the deviation. It will be appreciated that a conventional feedback or responsive control system may further be adapted to comprise an adaptive and/or predictive component, wherein response to a given condition may be tailored in accordance with modeled and/or previously monitored reactions to provide a reactive response to a sensed characteristic while limiting potential overshoots in compensatory action. For instance, acquired and/or historical data provided for a given system configuration may be used cooperatively to adjust a response to a system and/or process characteristic being sensed to be within a given range from an optimal value for which previous responses have been monitored and adjusted to provide a desired result. Such adaptive and/or predictive control schemes are well known in the art, and as such, are not considered to depart from the general scope and nature of the present disclosure.

Control Elements

Sensing elements contemplated within the present context, as defined and described above, can include, but are not limited to, means for monitoring operational parameters such as gas flow, pressure within the residue conditioning chamber, and temperature at various locations within the system. The sensing elements optionally include means for analyzing the chemical composition of the residue gas.

The data obtained from the sensing elements is used to determine if, for example, there needs to be more air injected into the system, or if the residue material input rate needs to be adjusted. Accordingly, ongoing adjustments to operating parameters, as determined by the control system, enable the residue conditioning process to be carried efficiently and completely, ensuring that the residue is fully converted to a slag material and gaseous products having desired chemical compositions.

Where continuous operation of the residue conditioning chamber is desired, the control subsystem provides for such sustained operation by ensuring, for example, that the torch has an adequate melting capacity to process a steady-state addition of the residue to the conditioner.

The following operational parameters may be intermittently or continuously monitored by the sensing elements, and the data obtained are used to determine whether the system is operating within the optimal set point, and whether, for example, there needs to be more power delivered by the torches, more air injected into the system, or if the residue material input rate needs to be adjusted.

Temperature

In one embodiment of the invention, the control system comprises means to monitor the temperature at sites located throughout the system. Means for monitoring the temperature may be located on the outside wall of the chamber, at locations throughout the interior of the chamber, or in the gas handling subsystems as may be required. The means for monitoring the temperature may be thermocouples or optical thermometers installed at locations in the system as required.

In one embodiment of the invention, the temperature monitoring means are provided as one or more optical thermometers for measuring the surface temperature of the surface upon which they are aimed. In one embodiment, the residue conditioning chamber is provided with one or more vapour space thermocouples mounted in ceramic thermowells above the molten slag reservoir. In one embodiment, the residue conditioning chamber is provided with external skin mounted thermocouples mounted on the outer metal shell.

Means for monitoring the temperature of the residue gas may also be located at the residue gas outlet, as well as at various locations throughout the residue gas conditioning system.

If a subsystem for recovering the sensible heat in the residue gas produced by the residue conditioning process is employed (such as a heat exchanger or similar technology), a means for monitoring the temperature at points in the heat recovery subsystem may be incorporated. For example, the temperature may be monitored at the coolant fluid inlet and outlet, as well as at the residue gas inlet and outlet.

System Pressure

In one embodiment of the invention, the control system comprises means to monitor the pressure within the residue conditioning chamber, as well as throughout the entire residue conditioning system. These pressure monitoring means may include pressure sensors such as pressure transducers, pressure transmitters or pressure taps located anywhere system, for example on a vertical wall of the conditioning chamber. Data relating to the pressure of the system is used by the control system to determine whether adjustments to parameters such as blower speed or valve settings are required.

In one embodiment, the pressure in the different components in the system is monitored. In this manner, a pressure drop or differential from one component to another can be monitored to rapidly pinpoint developing problems during processing.

In one embodiment, the pressure in the residue conditioning chamber is monitored by a pressure transmitter tapped into the vapour space of the chamber.

Gas Flow Rate

In one embodiment of the invention, the control system comprises means to monitor the rate of residue gas flow at sites located throughout the system. Fluctuations in the gas flow may occur as the result of non-homogeneous conditions in the conditioning process (e.g. malfunctions in the torch or interruptions in the residue feed). If fluctuations in gas flow persist, the system may be shut down until the problem is solved.

Gas Composition

In one embodiment of the invention, the control system comprises means to monitor the composition of the residue gas. The residue gas produced during the residue conditioning process can be sampled and analyzed using methods well known to the skilled technician. As discussed previously, air inputs may be provided to ensure that the carbon content of the residue is completely converted to a useful gas product. In order to ensure that the conditioning process is carried out efficiently and safely, the composition of the residue gas may be monitored to determine whether there is an excess of oxygen in the residue gas exiting the chamber. In one embodiment, the composition of the residue gas is monitored at the chamber's gas outlet.

One method that can be used to determine the chemical composition of the product gas is through gas chromatography (GC) analysis. Sample points for these analyses can be located throughout the system. In one embodiment, the gas composition is measured using a Fourier Transform Infrared (FTIR) Analyser, which measures the infrared spectrum of the gas.

Although high temperature gas analysis means exist, one skilled in the art can appreciate that it may be required to cool the gas prior to analyzing its composition, depending upon the type of system used for gas analysis.

In one embodiment, sampling ports are installed at locations throughout the residue gas handling subsystem.

Response elements contemplated within the present context, as defined and described above, can include, but are not limited to, various control elements operatively coupled to process-related devices configured to affect a given process by adjustment of a given control parameter related thereto. For instance, process devices operable within the present context via one or more response elements, may include, but are not limited to, means for adjusting various operational parameters such as the rate of addition of the residue, air and/or steam, as well as operating conditions, such as power to the torch, torch position and system pressure.

Plasma Heat Source

In one embodiment of the invention, the control system comprises means to adjust the power, and optionally the position, of the plasma heat source. For example, when the temperature of the melt is too low, the control system may command an increase in the power rating of the plasma heat source; conversely, when the temperature of the chamber is too high, the control system may command a drop in the power rating of the plasma heat source.

In one embodiment, the power of the torch is maintained at a level that is proportional to the rate of the residue addition, i.e., an increase in the residue feed rate results in an increase in the torch power. The torch power can also be adjusted to react to changes in the characteristics and composition of the residue, for example, with respect to its melting properties such as temperature, specific heat capacity, and heat of fusion.

In one embodiment, the position of the plasma heat source is adjustable to ensure complete coverage of the melt pool, and the elimination of areas of incompletely reacted materials.

Residue Feed Rate

In one embodiment of the invention, the control system comprises means to adjust the rate of addition of the residue. The material is added to the residue conditioning chamber using a number of possible input means that are selected and adapted as required for the form of the material added. The residue may be added in a continuous manner, for example, by using a rotating screw or auger mechanism. Alternatively, the residue can be added in a discontinuous fashion, for example, by using a pusher ram to add material in portions as required.

Where the residue input means comprises a series of pusher rams, the control system may employ limit switches or other means of travel control such as computer controlled variable speed motor drives to control the length, speed and/or frequency of the ram stroke so that the amount of residue fed into the conditioning chamber with each stroke can be controlled. Where the residue input means comprises one or more screw conveyors, the rate of addition of the residue to the conditioning chamber may be controlled by adjusting the conveyor speed via drive motor variable frequency drives. The feed rate is adjusted as required to ensure acceptable temperature control, according to the melting capability of the plasma torches, and to prevent the accumulation of unconditioned materials in the residue conditioning chamber. The residue input rate can also be varied to accommodate varying residue melting temperature properties.

Addition of Air and/or Steam

In one embodiment of the invention, the control system comprises means to adjust the rate and/or amounts of air inputs into the residue conditioning chamber. In one embodiment of the invention, the control system comprises means to adjust the rate and/or amounts of steam inputs into the conditioning chamber.

As discussed previously, air and/or steam may be added to the conditioning chamber to ensure complete conversion of unreacted carbon, as required by the varying carbon content of the residue being conditioned.

Air inputs may also be provided as required to maintain optimum processing temperatures while minimizing the cost of plasma heat required in the conditioning process. As such, the amount of air injection is maintained to ensure the maximum conversion of carbon to carbon monoxide with the minimum plasma heat requirement to carry out the process.

The amount of air inputs are also controlled to ensure that an excess of oxygen is not introduced into the conditioning chamber, to avoid producing a residue gas product having unsafe (i.e., ignitable) levels of oxygen.

Pressure

In one embodiment of the invention, the control system comprises means to adjust the pressure within the residue conditioning system, thereby maintaining a desired pressure in the system within certain defined tolerances. Any pressure variations caused for example, when the plasma torch power or residue feed rate is adjusted, are corrected by making adjustments to certain operational parameters as determined by the control system.

In one embodiment, the system is maintained at an operating pressure that does not exceed the pressure of upstream elements such as the source of the residue material (e.g., a gasification chamber or feed hopper). Maintaining the pressure at or below that of upstream components ensures that there is a minimal driving force urging the flow of the residue gas back toward the upstream component through, for example, the screw conveyors.

In one embodiment, the system is maintained under slight negative pressure relative to atmospheric pressure to prevent gases being expelled into the environment.

In one embodiment, the means for adjusting the internal pressure is provided by a valve at a location downstream from the residue conditioning chamber, for example, at the outlet of the residue gas conditioning subsystem. Adjustments to the pressure are made by opening or closing the valve in response to measured changes in the system pressure. A controller calculates the valve position needed to achieve the desired operating pressure.

In one embodiment, the means for adjusting the internal pressure is provided by an induction blower located downstream of the residue conditioning chamber that operates by pulling the residue gas out of the conditioning chamber. The induction blower thus employed maintains the system at atmospheric or negative pressure. In one embodiment, a control valve is provided in the gas outlet line to increase or restrict the flow of gas that is being removed by the downstream residue gas blower.

In systems in which positive pressure is maintained, the blower is operated such that the rate of removal of the residue gas is decreased, or even shut off, so that the gases are forced to “push” their way through the system resulting in a higher (positive) pressure.

In response to data acquired by pressure sensors located throughout the system, the speed of the downstream induction blower is adjusted according to whether the pressure in the system is increasing (whereby the fan will increase in speed) or decreasing (whereby the fan will decrease in speed). In one embodiment, data relating to the pressure at points throughout the system are obtained on a continuous basis, thereby allowing the control system to make frequent adjustments to the fan speed to maintain the system pressure within a predetermined set point.

The invention will now be described with reference to a specific example. It will be understood that the following example is intended to describe an embodiment of the invention and is not intended to limit the invention in any way.

### EXAMPLES

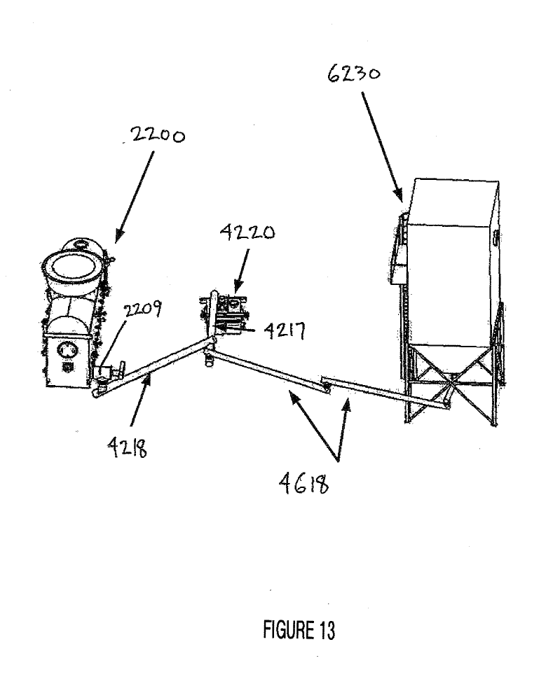

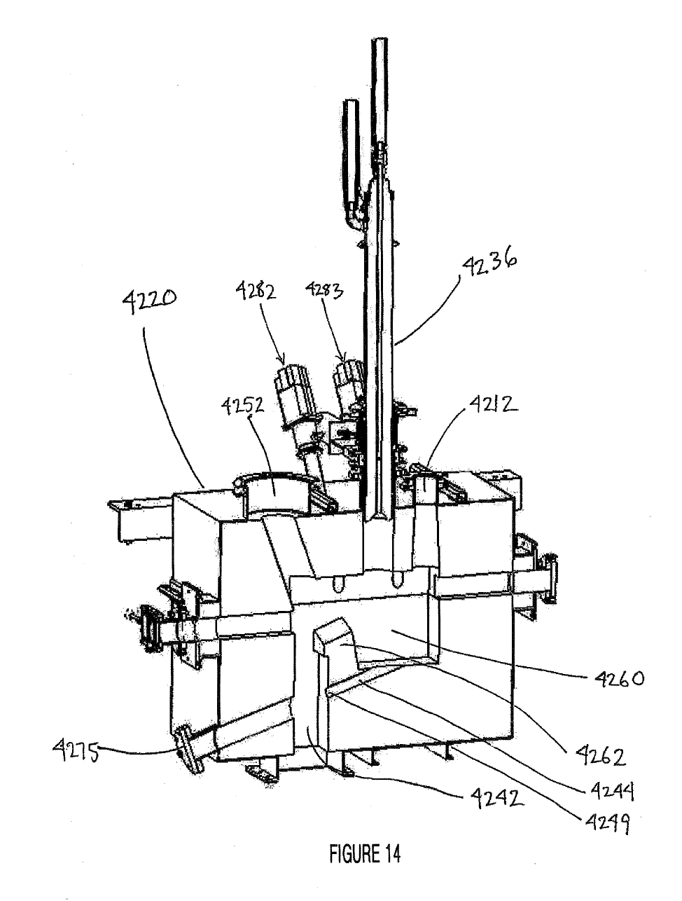

The present example is to provide an exemplary embodiment of the residue conditioning system of the present invention. Accordingly, the present example, as depicted in FIGS. 13 to 17, is provided to condition the residual matter produced in a typical gasification system during the gasification of carbonaceous feedstock. The sources of the residue to be conditioned are therefore the gasifier 2200 and the baghouse filter 6230 of a downstream gas conditioning subsystem of the gasification system. According to this example, the gasifier residue is removed from the gasifier 2200 by a first screw conveyor 2209 mounted at the end of the gasifier 2200. The first screw conveyor 2209 is provided as a toothed or serrated screw to break up agglomerated material. The residue is then conveyed via a gasifier residue screw conveyor 4218 to a main residue screw conveyor 4217. The baghouse residue is conveyed from the baghouse 6230 via a baghouse residue screw conveyor 4618 into the main residue screw conveyor 4217. The main screw conveyor 4217 passes the combined residues into the top of the residue conditioning chamber 4220. A cross-sectional view of an exemplary conditioning chamber is depicted in FIG. 14.

The residue drops through the residue inlet 4212 located at the top of the conditioning chamber 4220 into a reservoir 4260 whose depth is determined by the height of a weir 4262, where it accumulates while undergoing heating by the plasma torch 4236. The level of the molten slag pool rises as more residue is added to the chamber 4220, until the level of the pool reaches the top of the weir 4262. Thereafter, as additional residue enters the reservoir 4260 and is conditioned, a corresponding amount of molten material overflows the weir 4262 and out of the chamber 4220 through a slag outlet 4242.

In order to remove metals that may have accumulated in the reservoir, the reservoir 4260 is provided with a metal tap port 4249 plugged with a soft refractory paste 4244 which may be periodically removed using the heat from an oxygen lance. Once the tap port 4249 has been opened and the chamber temperature has been raised sufficiently to melt the accumulated metals, the molten metals are tapped off from the bottom of the reservoir 4260.

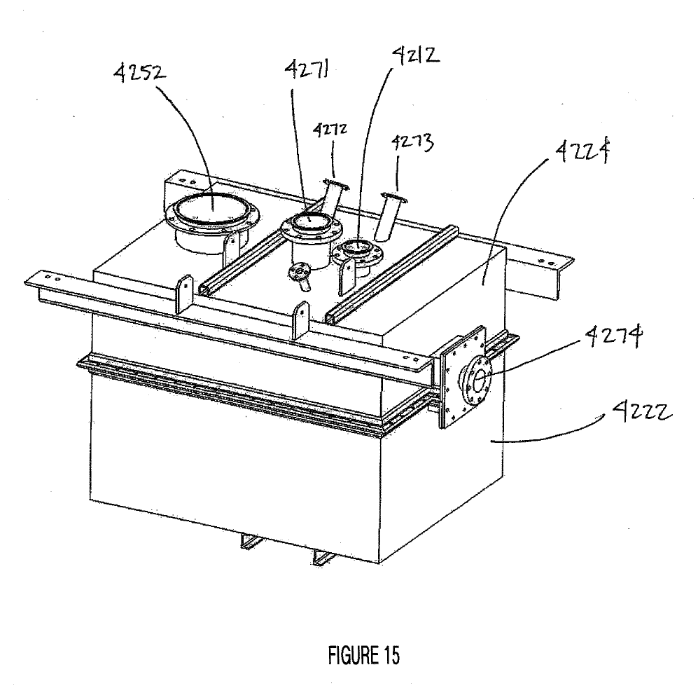

The exemplary chamber depicted in FIG. 15, shown disconnected from upstream and downstream components of the system, comprises a lower chamber portion 4222, where the reservoir is located, and an upper chamber portion 4224, comprising connections to the upstream residue source and the downstream gas conditioning subsystem. The chamber lower portion 4222 can therefore be removed from the chamber upper portion 4224 without disturbing any connections between the chamber and upstream or downstream components of the system. To facilitate the lowering of the lower chamber portion 4222 away from the upper portion 4224, the chamber 4220 is suspended from a support structure by supporting means 4229 attached to the upper portion 4224. Thus the lower portion 4222 can be dropped away from the upper portion 4224 to facilitate maintenance.

The exemplary chamber depicted in FIGS. 14 and 15, includes a port 4271 for receiving the plasma torch 4236, a residue inlet 4212 through which the residue is received, and a gas outlet 4252 through which the residue gas passes into a downstream gas conditioning subsystem 4250. This exemplary chamber also includes two ports 4272 and 4273 for mounting optical thermometers 4282 and 4283, a port 4274 for mounting a burner for preheating the conditioning chamber, and a port 4275 for mounting an oxygen lance.

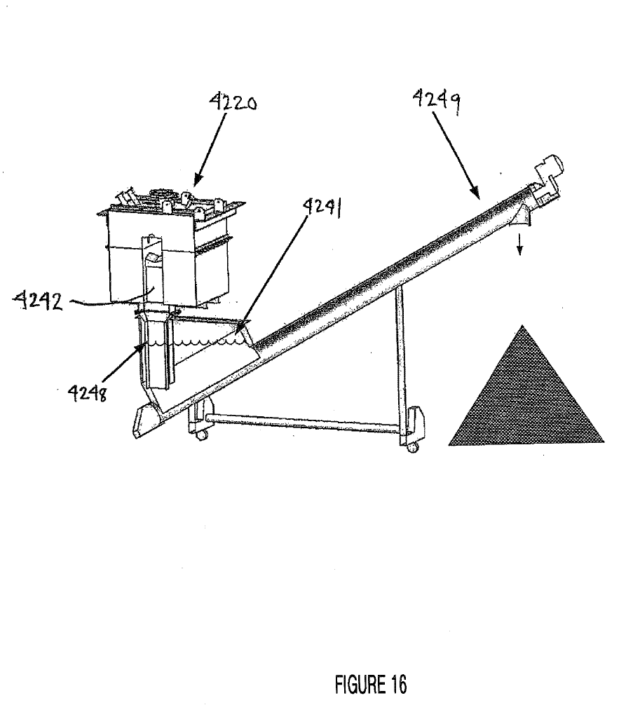

The cross sectional view of the exemplary chamber depicted in FIG. 16 shows the slag outlet 4242 and the water seal duct 4248 through which the molten slag falls into the water tank 4241 below. The water seal duct 4248 is provided to ensure that the residue conditioning environment is sealed to the atmosphere. The cooled and solidified slag is removed from the water bath using a wet conveyer system 4249 and is collected for disposal or later use.

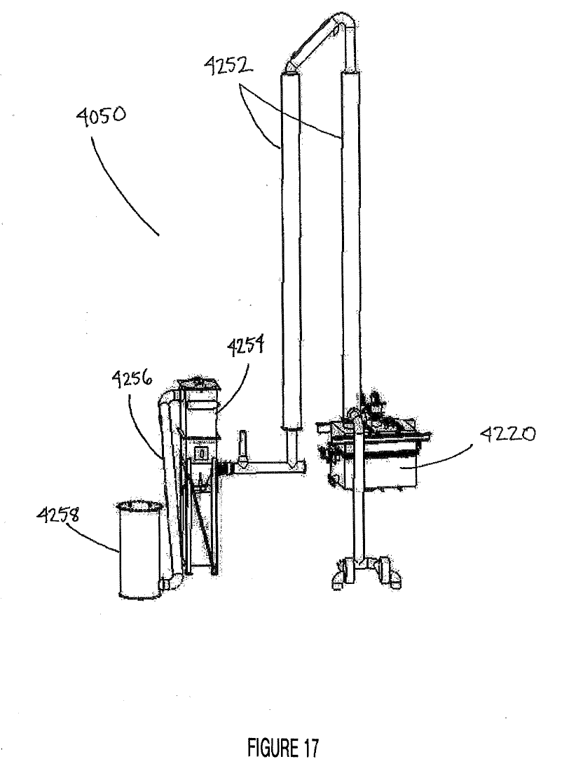

As shown in FIG. 17, the residue gas exits the residue conditioning chamber 4220 through the gas outlet 4252 and is passed into a residue gas conditioning subsystem 4250. In the residue gas conditioning subsystem, the residue gas undergoes a pre-cooling step in an indirect air-to-gas heat exchanger 4252 prior to being passed through a baghouse filter 4254 to remove particulates and a proportion of the heavy metal contaminants. The residue gas is then cooled using a second heat exchanger 4256 before it is passed through an activated carbon bed 4258 for the further removal of heavy metals and particulate matter.

Control Strategy

The following describes typical control strategies according to the present example. In the present example, the sensing elements include at least two optical thermometers for measuring the surface temperature of the molten slag pool, a plurality of vapour space thermocouples mounted in ceramic thermowells above the melt pool, and a plurality of external skin mounted thermocouples mounted on the outer metal shell. The sensing elements of this example also include a pressure transmitter for measuring the process pressure inside the residue conditioning chamber. In the present example, the operational parameters to be adjusted include the power of the plasma heat source, the residue feed rate, and the pressure within the system.

According to one control strategy suitable for this example, the temperature differential as measured by the at least two optical thermometers is determined. One optical thermometer is aimed at the melt pool below the torch, the other at the melt pool near the weir. If the temperature measured near the weir is cooling off relative to the temperature measured below the torch, then more torch power is applied to ensure that the slag is maintained in a molten state until exhausted from the chamber.

According to a second control strategy suitable for this example, the temperature as measured by the optical thermometers is determined, and compared to a predetermined set point. For example, a set point of between about 1400-1800° C., known to be above the melting temperature of most components of the residue to be conditioned, is selected and entered into the controller. The control system will then adjust the torch power as required to meet this set point.

In the present example, the state of material in the molten slag pool is not measured directly, but is inferred by measurements obtained using both optical thermometers directed at the surface of the pool and vapour space thermocouples. For example, if the temperature measured by these devices falls below the predetermined temperature set point, this may be an indication of the presence of unmelted material. Accordingly, the control system will adjust operating parameters as required, for example, by momentarily slowing the residue feed rate, or increasing the plasma torch power.

In the present example, the residue feed rate is adjusted as required to ensure acceptable temperature control, according to the melting capability of the plasma torches, and to prevent the accumulation of unconditioned materials in the residue conditioning chamber.

In the present example, the pressure in the slag chamber is monitored by a pressure transmitter tapped into the vapour space of the vessel, and a control valve in the gas outlet line is adjusted to increase or restrict the flow of gas being removed by a downstream syngas gas blower. The controller calculates the valve position needed to achieve the desired operating pressure.

The embodiment of the invention in which an exclusive property or privilege is claimed are defined as follows:

1. A system for converting a residue into a molten substance and a gas having a heating value, comprising:
a) a refractory-lined residue conditioning chamber comprising:
(i) a residue inlet in communication with a residue source,
(ii) a gas outlet,
(iii) a plasma heat source port, and
(iv) a slag outlet; and
b) a plasma heat source mounted in the plasma heat source port.

2. The system according to claim 1, further comprising a control subsystem comprising one or more sensing elements for real-time monitoring of operating parameters of the system; and one or more response elements for adjusting operating conditions within the system to optimize the conversion reaction, wherein the sensing elements and the response elements are integrated within said system, and wherein the response elements adjust the operating conditions within the system according to the data obtained from the sensing elements.

3. The system according to claim 2, wherein the gas outlet is in communication with a gas conditioning subsystem.

4. The system according to claim 2, wherein the residue inlet is connected to the residue source via one or more screw conveyors.

5. The system according to claim 2, wherein the residue inlet is in direct communication with the residue source.

6. The system according to claim 4 or 5, wherein the residue source is a low temperature carbonaceous feedstock gasifier.

7. The system according to any one of claims 1 to 6, wherein the conditioning chamber further comprises one or more process additive inlets.

8. The system according to claim 7, wherein the process additive inlet is an air inlet.

9. A system for converting a residue into a molten substance and a gas having a heating value, comprising:
a) a refractory-lined residue conditioning chamber comprising:
(v) a residue inlet in communication with a residue source,
(vi) a gas outlet,
(vii) a plasma heat source port, and
(viii) a slag outlet;
b) a plasma heat source mounted in the plasma heat source port; and
c) a control subsystem comprising one or more sensing elements for real-time monitoring of operating parameters of the system; and one or more response elements for adjusting operating conditions within the system to optimize the conversion reaction, wherein the sensing elements and the response elements are integrated within said system, and wherein the response elements adjust the operating conditions within the system according to the data obtained from the sensing elements.

10. A process for converting a residue into a molten substance and a gas having a heating value in a conditioning chamber using heat from a plasma heat source, comprising the steps of:
inputting the residue from a residue source into the conditioning chamber;
applying the heat from the plasma heat source sufficient to melt the residue into the molter substance in the presence of one or more process additives selected from air, steam, silica, alumina, lime or iron;
outputting the molten substance from the conditioning chamber; and
outputting the gas from the conditioning chamber and inputting the gas into a gas conditioning system for cooling and cleaning.
